(19) United States
(12) Patent Application Publication
(10) Pub. No.: US 2017/0084928 A1
(43) Pub. Date: Mar. 23, 2017

(54) ELECTROCHEMICAL CELL AND METHOD FOR PRODUCING AN ELECTROCHEMICAL CELL

(71) Applicant: Robert Bosch GmbH, Stuttgart (DE)

(72) Inventors: Friedrich Kneule, Rutesheim (DE); Imke Heeren, Stuttgart (DE); Markus Siebert, Tiefenbronn-Muehlhausen (DE); Martin Schubert, Stuttgart (DE); Thomas Loibl, Oberstdorf (DE); Inga Schellenberg, Karlsruhe (DE)

(21) Appl. No.: 15/265,604

(22) Filed: Sep. 14, 2016

(30) Foreign Application Priority Data
Sep. 18, 2015 (DE) 10 2015 217 944.3

(51) Int. Cl. H01M 8/00; B29C 45/16; C25B 1/04; H01M 12/06; C25B 9/06

(52) U.S. Cl. CPC H01M 8/004; H01M 12/06; C25B 9/06; C25B 1/04; B29C 45/1679; B29K 2029/00

(57) ABSTRACT

An electrochemical cell (10), in particular a fuel cell and/or an electrolytic cell and/or a metal-air cell, having at least one functional layer system (12), which is distinguished by the fact that at least one tubular support body (14) is formed, in which at least one tunnel-like structure (16) is formed, which adjoins the at least one functional layer system (12). A method for producing an electrochemical cell (10).

### BACKGROUND OF THE INVENTION

The present invention relates to an electrochemical cell, in particular a fuel cell and/or an electrolytic cell and/or a metal-air cell, having at least one functional layer system.

DE102012219104A1 discloses an electrochemical cell which has a tubular functional layer system and at least one support web, wherein the support web is formed at a distance from the tubular functional layer system. Moreover, the document shows a method for producing an electrochemical cell of this kind.

### SUMMARY OF THE INVENTION

In contrast, the present electrochemical cell, in particular fuel cell and/or electrolytic cell and/or metal-air cell, having at least one functional layer system, has the advantage that at least one tubular support body is formed, in which at least one tunnel-like structure is formed, which adjoins the at least one functional layer system. In this way, the mechanical stability of the electrochemical cell is additionally increased, wherein a high performance of the electrochemical cell can likewise be achieved.

Thus it is advantageous if the at least one tunnel-like structure forms a channel structure, in particular a channel structure which is at least substantially interconnected in terms of flow. As a result, the tunnel-like structure can adjoin the at least one functional layer system over a large area.

It is particularly advantageous if the at least one tunnel-like structure is formed in the manner of a network, in particular as at least one diffusion network and/or discharge network, through which preferably at least one fluid, in particular at least one oxygen-containing and/or nitrogen-containing fluid, flows. Uniform supply and/or discharge of at least one fluid, in particular an oxygen-containing and/or nitrogen-containing fluid, to and/or from the at least one functional layer system is thereby made possible.

The at least one tunnel-like structure is preferably of a honeycomb-like and/or ladder-like design. Supply and/or discharge of at least one fluid to and/or from the at least one functional layer system can thereby be designed in a selective way.

In an advantageous embodiment, at least one opening, in particular a selectively introduced opening, preferably a gas access opening, is formed in the at least one tubular support body, whereby supply and/or discharge of at least one fluid to and/or from the at least one functional layer system can additionally be improved.

It is advantageous if at least one opening is connected at least substantially to the at least one tunnel-like structure in terms of flow, thereby allowing supply and/or discharge of at least one fluid to and/or from the at least one functional layer system to be distributed uniformly over a large area of the at least one functional layer system.

It is particularly preferred if a multiplicity of openings is formed in the at least one tubular support body, preferably parallel to one another and/or opposite one another. Supply and/or discharge of at least one fluid to and/or from the at least one functional layer system can thereby additionally be increased and can furthermore be matched selectively to the configuration of the electrochemical cell.

The invention also relates to a method for producing an electrochemical cell, in particular a fuel cell and/or an electrolytic cell and/or a metal-air cell, in particular according to the above description, having at least one functional layer system. The method is distinguished by at least the following method steps:
a) application of at least one structural material to the at least one functional layer system, wherein the at least one structural material is provided to form at least one tunnel-like structure in at least one tubular support body, which adjoins the at least one functional layer system;
b) introduction of the at least one functional layer system, in particular with the at least one structural material, into at least one injection mold unit;
c) injection of at least one injection molded component into at least one injection mold unit;
d) removal of the structural material, in particular by heating.

In this way, efficient and economical production of an electrochemical cell is made possible.

Method step a) is preferably carried out by means of a screen printing method and/or a tampon printing method. Technically simple implementation of the method according to the invention can thereby be achieved.

It is particularly preferred if method step a) is carried out in such a way that at least one structural material is formed on the at least one functional layer system in an at least substantially interconnected manner, in particular in the manner of a network, preferably in the manner of a honeycomb and/or ladder. Appropriate configuration of the at least one structural material for the aim in view is thereby made possible. Such application can also be accomplished by 3-D printing.

### BRIEF DESCRIPTION OF THE DRAWINGS

Illustrative embodiments of the invention are shown schematically in the drawings and explained in greater detail in the following description. In the drawings:

FIG. 1 shows a schematic longitudinal section through an embodiment of an electrochemical cell according to the invention;

FIG. 2 shows a schematic detail of a tubular support body without the functional layer system in an electrochemical cell according to the invention;

FIG. 3 shows a schematic detail of a tubular support body without the functional layer system in another embodiment of an electrochemical cell according to the invention;

FIG. 4 shows a schematic longitudinal section through another embodiment of an electrochemical cell according to the invention;

FIG. 5 shows a schematic external view of another embodiment of an electrochemical cell according to the invention;

FIG. 6 shows a schematic illustration of a functional layer system and of a structural material to be applied in one embodiment of a method according to the invention;

FIG. 7 shows a schematic cross section through an injection mold unit that can be used in one embodiment of a method according to the invention;

FIG. 8 shows a schematic cross section through an injection mold unit that can be used in one embodiment of a method according to the invention, with injected injection molded components;

FIG. 9 shows a schematic cross section through an injection mold unit that can be used in another embodiment of a method according to the invention;

FIG. 10 shows a schematic cross section through an injection mold unit that can be used in another embodiment of a method according to the invention, with injected injection molded components.

Identical or similar components of the embodiments are denoted by the same reference signs.

### DETAILED DESCRIPTION

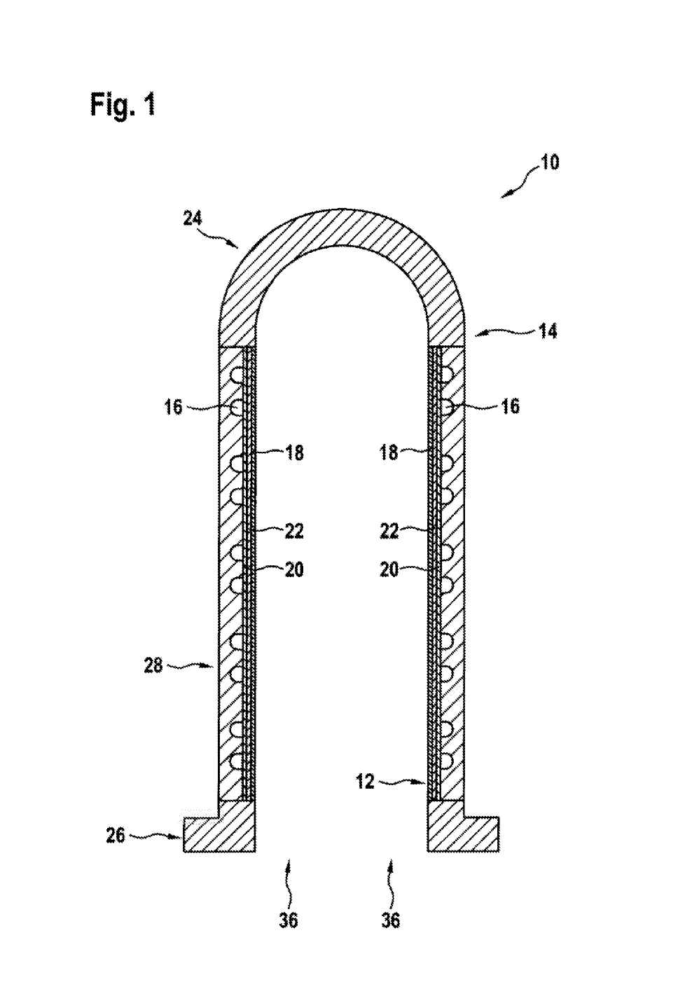

FIG. 1 shows a schematic longitudinal section through an embodiment of an electrochemical cell 10 according to the invention, which can be operated as a fuel cell and/or an electrolytic cell and/or a metal-air cell, having at least one functional layer system 12. The invention is distinguished by the fact that at least one tubular support body 14 is formed, in which at least one tunnel-like structure 16 is formed, which adjoins the at least one functional layer system 12. The tubular support body 14 in which the tunnel-like structure 16 is formed increases the mechanical stability in the cell as compared with the prior art, wherein the performance of the electrochemical cell 10 can likewise be improved sustainably through the fact that the tunnel-like structure 16 adjoins the functional layer system 12.

A tunnel-like structure 16 should be understood to mean a structure which is substantially covered by at least one material. In the embodiment shown, the tunnel-like structure 16 is covered by the material of the tubular support body 14. Thus, the tunnel-like structure 16 is formed in the tubular support body 14.

The functional layer system 12 is formed on an inner side of the tubular support body 14. As an alternative, however, it is also conceivable for the functional layer system 12 to be formed on an outer side of the tubular support body 14.

The functional layer system 12 comprises a first electrode 18, a second electrode 20 and an electrolyte 22 arranged therebetween. It is designed in such a way that the first electrode 18 is formed on a side facing the inner side of the tubular support body 14. Accordingly, the first electrode 18 faces into an interior of the electrochemical cell 10. The second electrode 20, in turn, is formed on a side facing the outer side of the tubular support body 14. Accordingly, the second electrode 20 rests against the tubular support body 14. Thus, the tunnel-like structure 16 adjoins the second electrode 20 of the functional layer system 12. As an alternative, however, it is also conceivable for the functional layer system to be designed in such a way that the first electrode 18 is formed on a side facing the outer side of the tubular support body 14 and the second electrode 20 is formed on a side facing the inner side of the tubular support body 14.

The tubular support body 14 is composed substantially of a ceramic material. In the embodiment shown, the tubular support body 14 is composed of a magnesium silicate. The magnesium silicate is a forsterite (Mg₂SiO₄).

The tubular support body 14 has a cap section 24, a foot section 26 and a central section 28. The cap section 24 and the foot section 26 of the tubular support body 14 are of gastight configuration. The central section 28 of the tubular support body 14 is of gas-permeable design. The gas permeability of the central section 28 of the tubular support body 14 is achieved by making the central section 28 of the tubular support body 14 porous.

During the operation of the electrochemical cell 10, a fluid is supplied on the outer side of the tubular support body 14 and/or discharged from the outer side of the tubular support body 14. Owing to the porosity of the central section 28 of the tubular support body 14, the fluid supplied and/or discharged can penetrate the central section 28 of the tubular support body 14 or diffuse through the central section 28 of the tubular support body 14. In this way, a fluid supplied can enter the tunnel-like structure 16, whereas a fluid discharged or to be discharged can leave the tunnel-like structure 16. Thus, a fluid supplied can be supplied to the second electrode 20 of the functional layer system 12, while a fluid to be discharged can be discharged from the second electrode 20.

During operation of the electrochemical cell 10, it is furthermore possible for another fluid to be supplied to the inner side of the tubular support body 14 and thus to reach the first electrode 18.

If the electrochemical cell 10 is operated as a fuel cell, the second electrode 20 of the functional layer system 12 is supplied with an oxidizing agent, in the embodiment shown oxygen-containing air (O₂+N₂), as a fluid. At the same time, the first electrode 18 of the functional layer system 12 is supplied with fuel, in the embodiment shown methane-containing natural gas (CH₄), as a further fluid. During this process, there are electrochemical reactions on the functional layer system 12, wherein heat and electric current are produced. In this case, the first electrode 18 acts as an anode, while the second electrode 20 acts as a cathode. As an alternative, it is also conceivable to pass a fuel to the second electrode 20 as the fluid and to pass an oxidizing agent to the first electrode 18 as the further fluid.

If the electrochemical cell 10 is operated as an electrolytic cell, a reducing agent, in the embodiment shown water or steam, is supplied to the second electrode 18 of the functional layer system 12 as a further fluid. At the same time, a voltage is applied to the first electrode 18 and the second electrode 20 of the functional layer system 12. During this process, there is an electrochemical reaction on the functional layer system 12, wherein the reducing agent is split at the first electrode 18 of the functional layer system 12. In the illustrative embodiment shown, the water (H₂O) is split into hydrogen (H₂) and oxygen (O₂) at the first electrode 18 of the functional layer system 12, wherein oxygen ions (O²) diffuse through the electrolyte 22 from the second electrode 18 to the cathode 20 and are released there as oxygen (O₂), releasing electrons at the same time. As an alternative, it is also conceivable to supply the reducing agent as a fluid to the second electrode 20 of the functional layer system 12.

If the electrochemical cell 10 is operated as a fuel cell and/or electrolytic cell, the electrochemical cell 10 can be taken to be a metal-air cell.

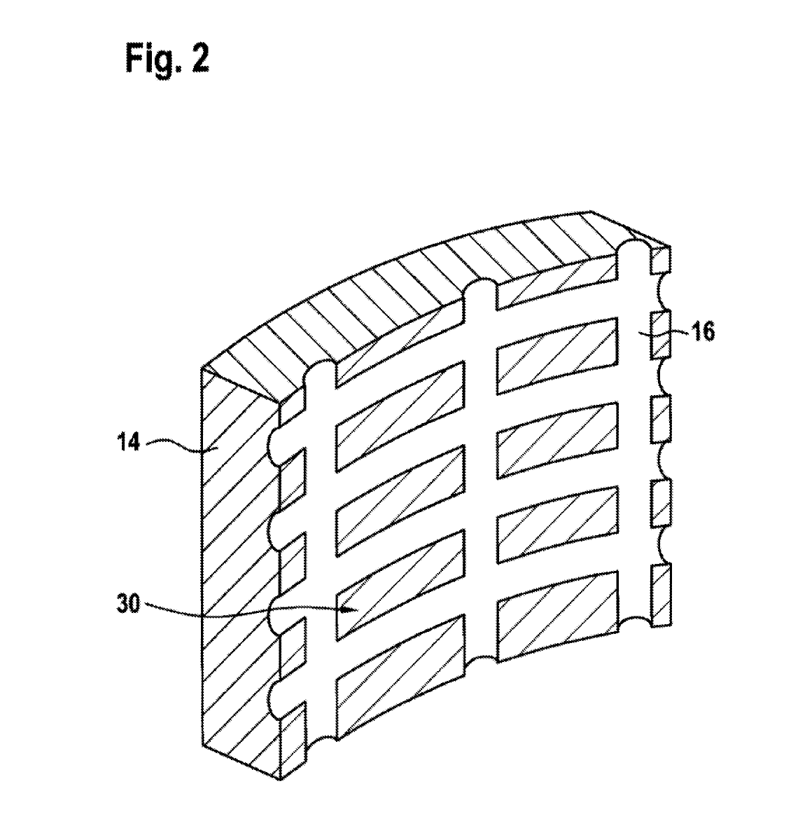

FIG. 2 shows a schematic detail of the tubular support body 14 without the functional layer system 12 in the electrochemical cell 10 according to the invention. The tunnel-like structure 16 forms a channel structure, in the illustrative embodiment shown a channel structure interconnected in terms of flow. The tunnel-like structure 16 thus adjoins the functional layer system 12 over a large area.

The tunnel-like structure 16 is formed in the manner of a network, as a diffusion network and discharge network, through which a fluid flows. Thus, in the illustrative embodiment shown, it is air, i.e. an oxygen-containing and/or nitrogen-containing fluid, which flows through the tunnel-like structure 16 during the operation of the electrochemical cell 10 as a fuel cell. During the operation of the electrochemical cell 10 as a fuel cell, there is thus a uniform supply of oxygen (O₂) to the second electrode 20 or cathode, while nitrogen (N₂), which, unlike oxygen, does not diffuse through the functional layer system 12, is discharged again. The performance of the electrochemical cell 10 is thereby sustainably increased. Thus, additional oxygen flowing through the porous tubular support body 14 or the central section of the tubular support body 14 can diffuse unhindered to the cathode. At the same time, the life of the electrochemical cell 10 can be extended since an undersupply of oxygen to the cathode is avoided and thus point-wise degradation of the functional layer system 12 is also avoided. As an alternative, the tunnel-like structure 16 or diffusion network can also be understood as an air reservoir or an oxygen reservoir.

In the embodiment shown in FIG. 2, the tunnel-like structure 16 is of ladder-like design. Thus, oxygen can be supplied and nitrogen discharged in a particularly uniform way. At the same time, the tubular support body 14 has relatively numerous and large boundary regions 30, which directly adjoin the functional layer system 12 and increase the mechanical stability of the electrochemical cell 10.

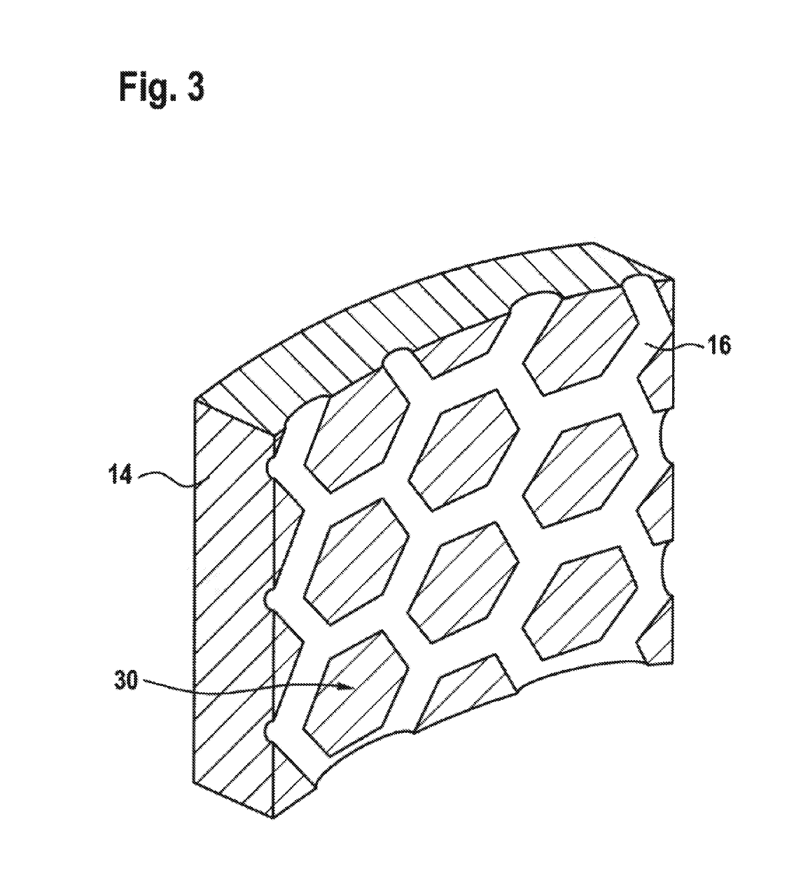

A schematic detail of a tubular support body 14 without functional layer system 12 in another embodiment of an electrochemical cell 10 according to the invention is shown in FIG. 3. Here, the tunnel-like structure 16 is of honeycomb-like design. Thus, the tunnel-like structure 16 can be selectively adapted and, as a result, the supply of a fluid to the second electrode 20 can also be designed selectively or made selectively more uniform.

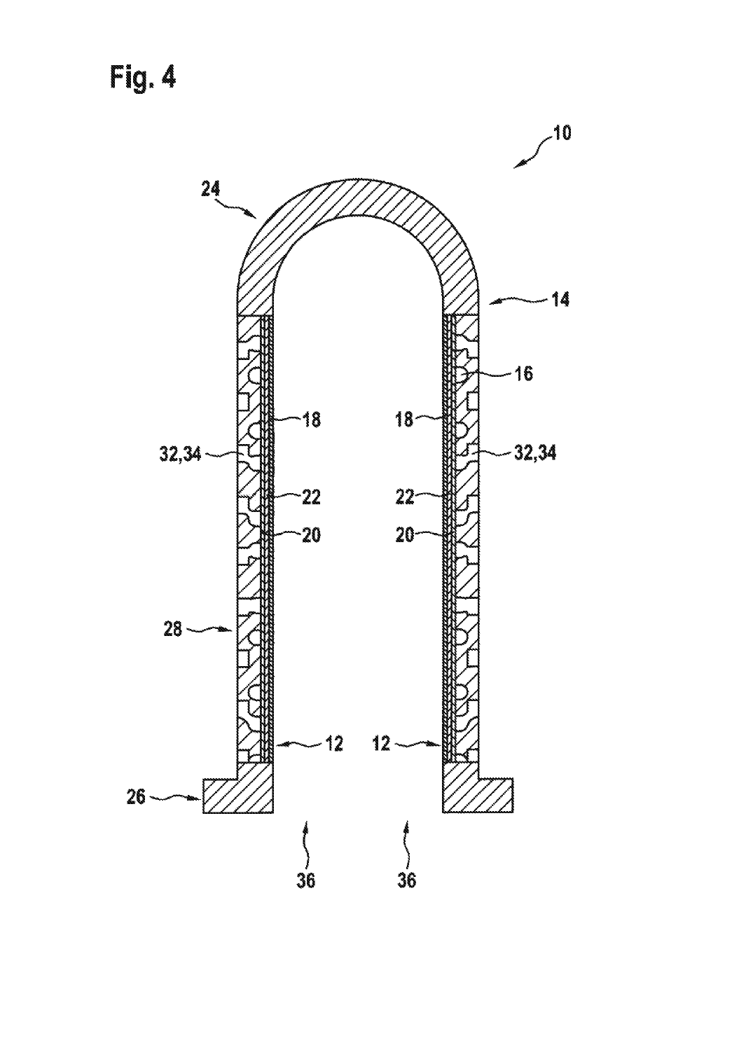

FIG. 4 shows a schematic longitudinal section through another embodiment of an electrochemical cell 10 according to the invention. Thus, openings 32 are formed in the tubular support body 10. The openings 32 are formed in the central section 28 of the tubular support body 14. The openings 32 are gas access openings 34. The openings 32 or gas access openings 34 are introduced selectively into the tubular support body 10. The supply and/or discharge of a fluid to and from the functional layer system 12 is/are additionally improved by the openings 32 or gas access openings 34.

The openings 32 should not be taken to include pores that are present owing to the porosity of the tubular support body 10. As already mentioned, these are selectively introduced openings, which are provided for the purpose of selectively improving supply and/or discharge.

The openings are connected substantially to the at least one tunnel-like structure 16 in terms of flow, thereby allowing a fluid supplied to enter the tunnel-like structure 16 more easily in terms of flow and thus also to be supplied to the functional layer system 12. A fluid to be discharged can likewise emerge more easily, in terms of flow, from the tunnel-like structure 16 through the openings 32 and thus be discharged from the functional layer system 12.

As already indicated, a multiplicity of openings 32 is formed in the tubular support body 14. In the embodiment shown, the openings 32 are formed centrally along the longitudinal axis of one tube half 36 of the electrochemical cell 10, in a region 38. Thus, the openings 32 are formed on mutually opposite sides, in the illustrative embodiment shown on mutually opposite sides of the electrochemical cell 10. Moreover, the openings 32 in the illustrative embodiment shown are formed parallel to one another.

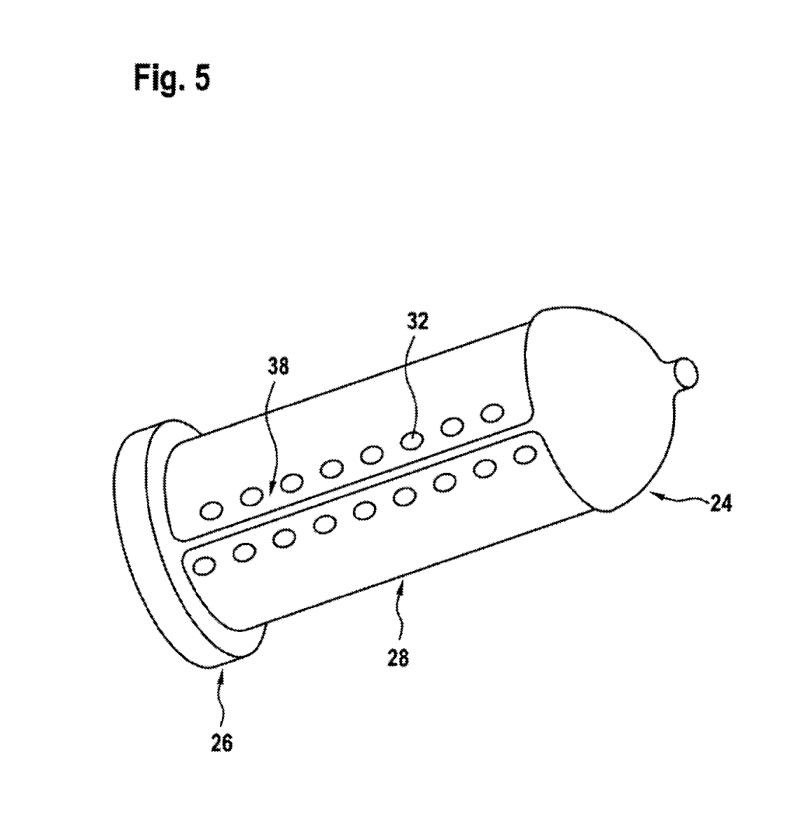

A schematic external view of another embodiment of an electrochemical cell 10 according to the invention is shown in FIG. 5. By virtue of the multiplicity of openings 32, supply and/or discharge can be matched selectively to the architecture of the cell. In the embodiment shown, the openings 32 are likewise formed centrally along the longitudinal axis of one tube half 36 of the electrochemical cell 10, in a region 38. In this case, the openings 32 are distributed uniformly over the region 38 and centrally along the longitudinal axis of one tube half 36 of the central section 28 of the tubular support body 14.

As an alternative, however, it is also conceivable for the openings 32 to be distributed nonuniformly in a selective way in order to selectively influence the supply and/or discharge of fluids. It would thereby be possible to match the supply and/or discharge of fluids to an external flow around the electrochemical cell 10, for example. For example, the number of openings 32 could be higher in a lower region of the electrochemical cell 10 than in an upper region of the electrochemical cell 10.

As an alternative, it is also conceivable for the openings 32 to be introduced selectively around the entire tubular support body 14 or the central section 28 of the tubular support body 14.

The invention also relates to a method for producing an electrochemical cell 10 or a fuel cell and/or electrolytic cell and/or metal-air cell having at least one functional layer system 12. The method is distinguished by at least the following method steps:
a) application of a structural material 40 to one functional layer system 12, wherein the structural material 40 is provided to form a tunnel-like structure 16 in a tubular support body 14, which adjoins the functional layer system 12;
b) introduction of the functional layer system 12, with the structural material 40, into an injection mold unit 42;
c) injection of injection molded components into the injection mold unit 42;
d) removal of the structural material 40 by heating.

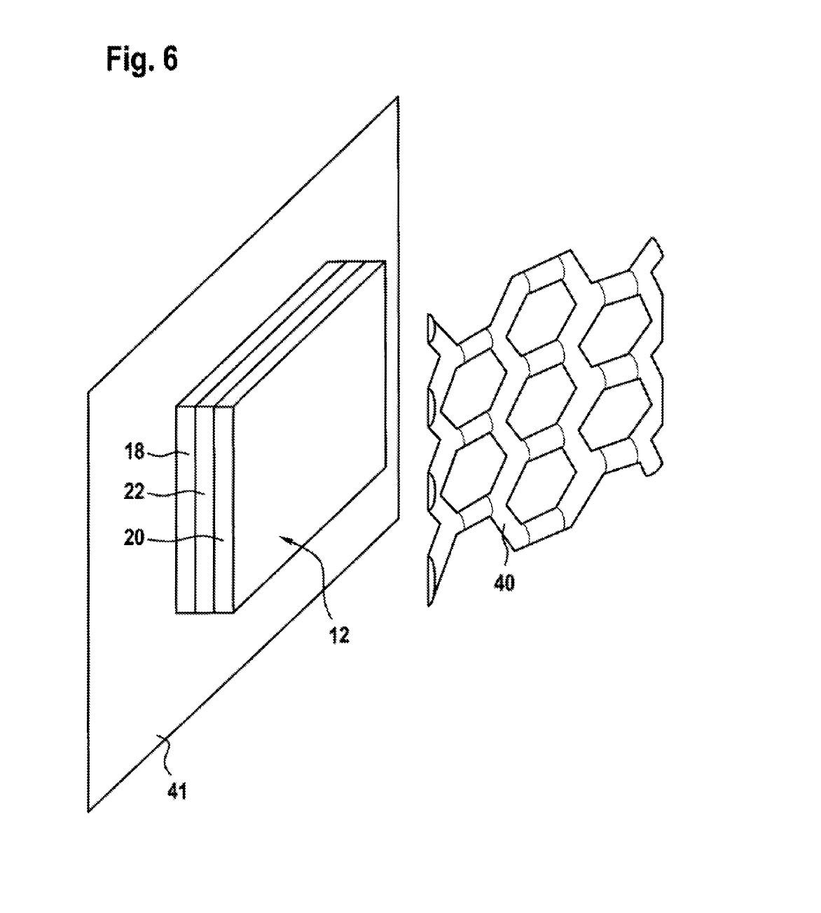

A schematic illustration of a functional layer system 12 and of a structural material 40 to be applied in accordance with the method according to the invention is shown in FIG. 6. In this case, the structural material 40 is shown at a distance from the functional layer system 12 to enable it to be shown more clearly.

The functional layer system 12 is printed onto a transfer material 41, wherein the exposed top layer is the second electrode 20. The structural material 40 is then applied to the functional layer system 12 in accordance with method step a). In the embodiment shown, the transfer material 41 is paper with a sugar coating.

In the embodiment shown, method step a) is carried out by means of a screen printing method. Technically simple and dimensionally precise formation of the structural material 40 is thus possible. As an alternative, it is also conceivable for method step a) to be carried out by means of a tampon printing method. It is likewise also conceivable for method step a) to be carried out by means of a method which includes both a screen printing process and a tampon printing process.

Method step a) is carried out in such a way that the structural material 40 is formed in a substantially interconnected way on the functional layer system 12. The structural material 40 is formed in the manner of a network. In the embodiment shown, the structural material 40 is formed in the manner of a honeycomb. It is likewise conceivable for the structural material 40 to be formed in the manner of a ladder or to have some other network-like structure. This makes it possible for the tunnel-like structure 16 to form in the manner of a network over a large area of the functional layer system 12 as the method progresses.

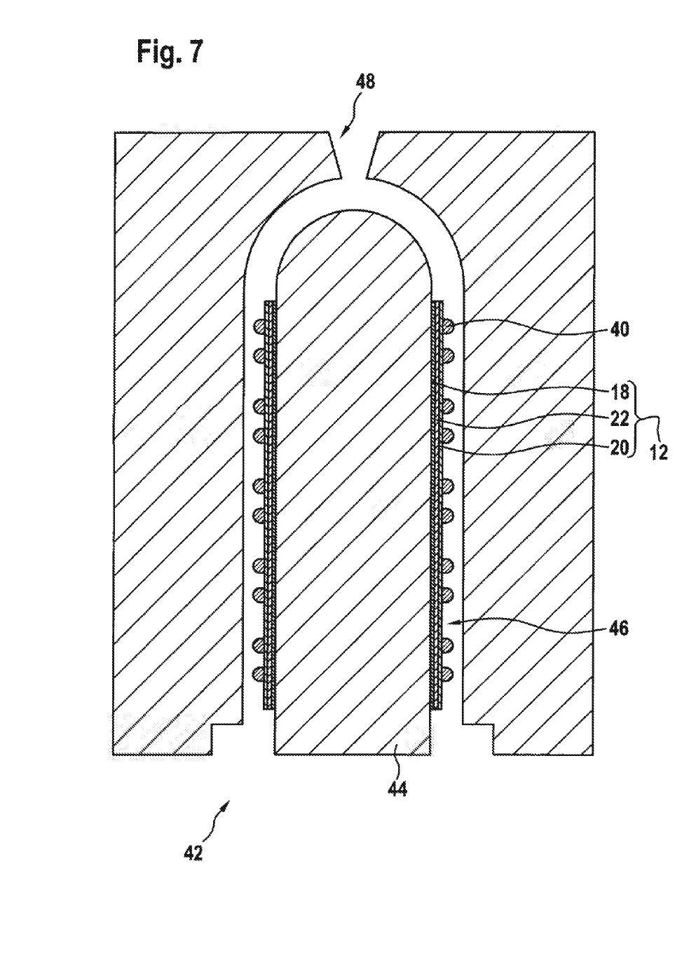

As already mentioned, the functional layer system 12, with the structural material 40, is then introduced into an injection mold unit 42 in accordance with method step b). In corresponding fashion, FIG. 7 shows a schematic cross section through an injection mold unit 42 used for the method shown.

The injection mold unit 42 has an injection molding core 44 and an injection molding cavity 46. The functional layer system 12 is applied with the structural material 40 to the injection molding core 44 by winding the transfer material made of paper, on which the functional layer system 12 and the structural material 40 are printed, around the injection molding core 44. During this process, care is taken to ensure that the transfer material is not wound too tightly around the injection molding core 44, so that subsequent removal of the injection molding core 44 is possible. The injection molding core 44 is then introduced into the injection molding cavity 46 together with the functional layer system 12 and the structural material 40.

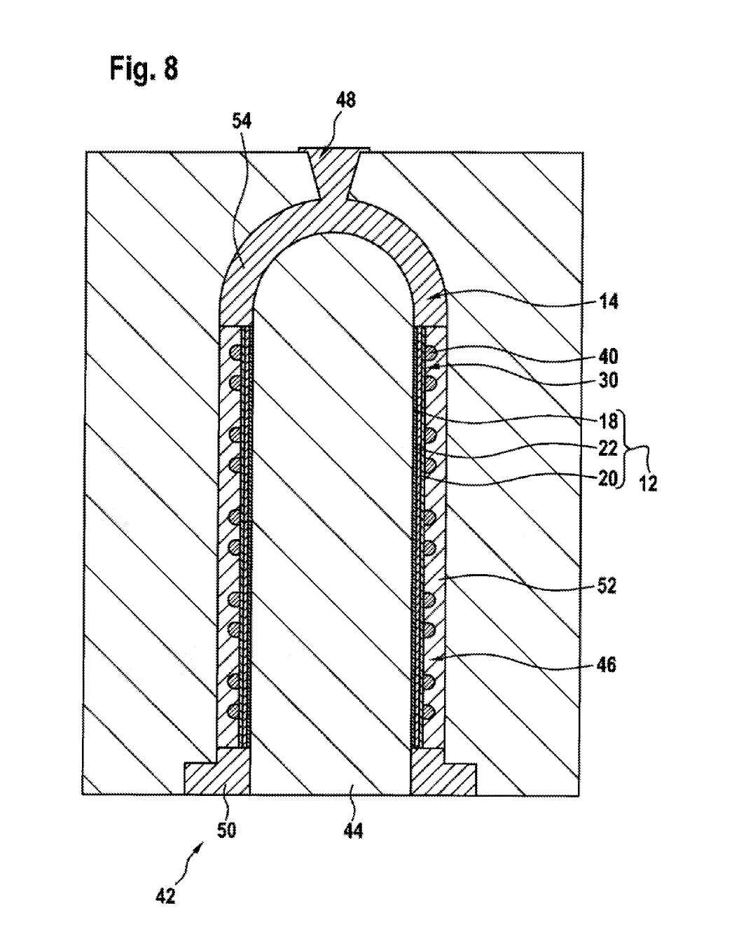

Injection molded components 50, 52, 54 are then injected into the injection mold unit 42 via a gate 48, using the 2-component injection molding method, in accordance with method step c). In corresponding fashion, FIG. 8 shows a schematic cross section through an injection mold unit 42 that can be used in one embodiment of a method according to the invention, said unit having injected injection molded components 50, 52, 54.

Both the functional layer system 12 and the injection molded components 50, 52, 54 contain a hot melt binder component, in the embodiment shown polyvinyl butyral, ensuring that the functional layer system 12 bonds to at least one injection molded component 50, 52, 54, in the embodiment shown to the second injection molded component 52, during injection. In the embodiment shown, the bonding of the functional layer system 12 to the injection molded component 52 takes place at least substantially in the boundary regions 30 between the structural material 40.

In the illustrative embodiment shown, the injection molded components 50, 52, 54 are a first injection molded component 50, which forms the foot section 26 of the tubular support body 14, a second injection molded component 52, which forms the central section 28 of the tubular support body 14, and a third injection molded component 54, which forms the cap section 24 of the tubular support body 14.

The first injection molded component 50 and the third injection molded component 54 have the same composition of material in the embodiment shown. The first injection molded component 50 and the second injection molded component 54 permit a gastight design of the foot section 26 and of the cap section 24.

The second injection molded component 52, in contrast, has a composition of material which includes pore formers. Thus, a porous design of the central section 28 is made possible by the second injection molded component 52 in the further method.

As shown in FIG. 8, the injection molded components 50, 52, 54, in the embodiment shown the second injection molded component 52, are injected in such a way that they cover the structural material 40, thereby making possible the formation of a stable, interconnected tubular support body 14.

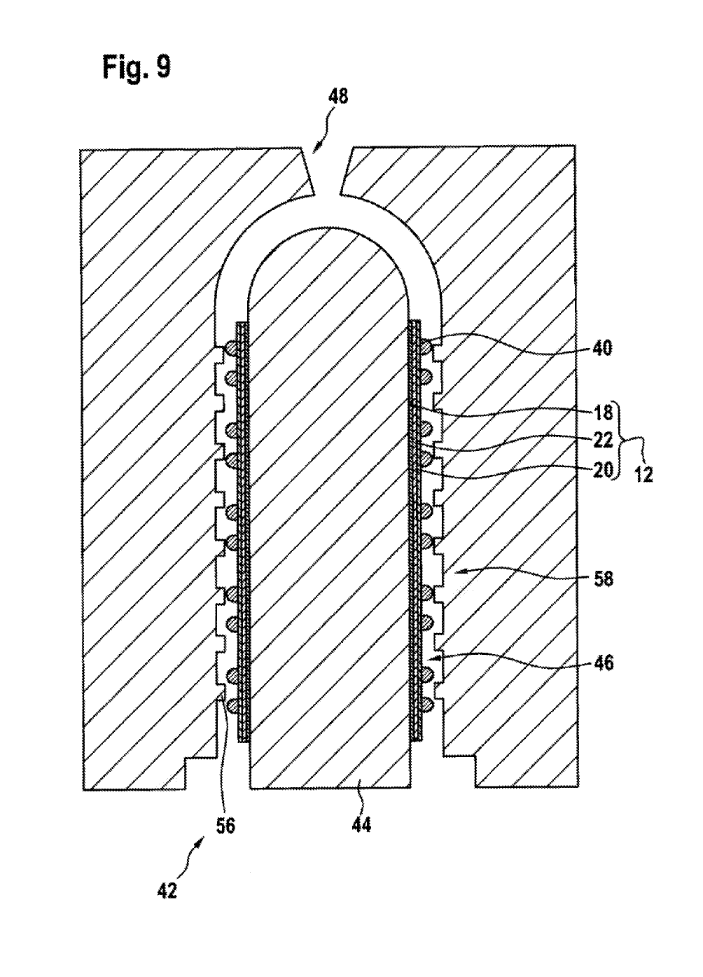

FIG. 9 shows a schematic cross section through an injection mold unit 42 of another embodiment of a method according to the invention. The injection mold unit 42 has bosses 56 or pins. In the embodiment shown, the bosses 56 are formed on the inner side of the injection molding cavity 46. The bosses 56 are designed in such a way that they form openings 32 in the tubular support body 14 during the process. Thus, the bosses 56 are formed in a central region 58, in which the second injection molded component 52 for the central section 28 of the tubular support body 14 is injected into the injection mold unit 42. Here, the central region 58 extends along a centrally extending longitudinal axis of one half of the injection molding cavity 46. Accordingly, the bosses 56 are formed opposite one another on the inner side of the injection molding cavity 46. Moreover, the bosses 56 are formed parallel to one another.

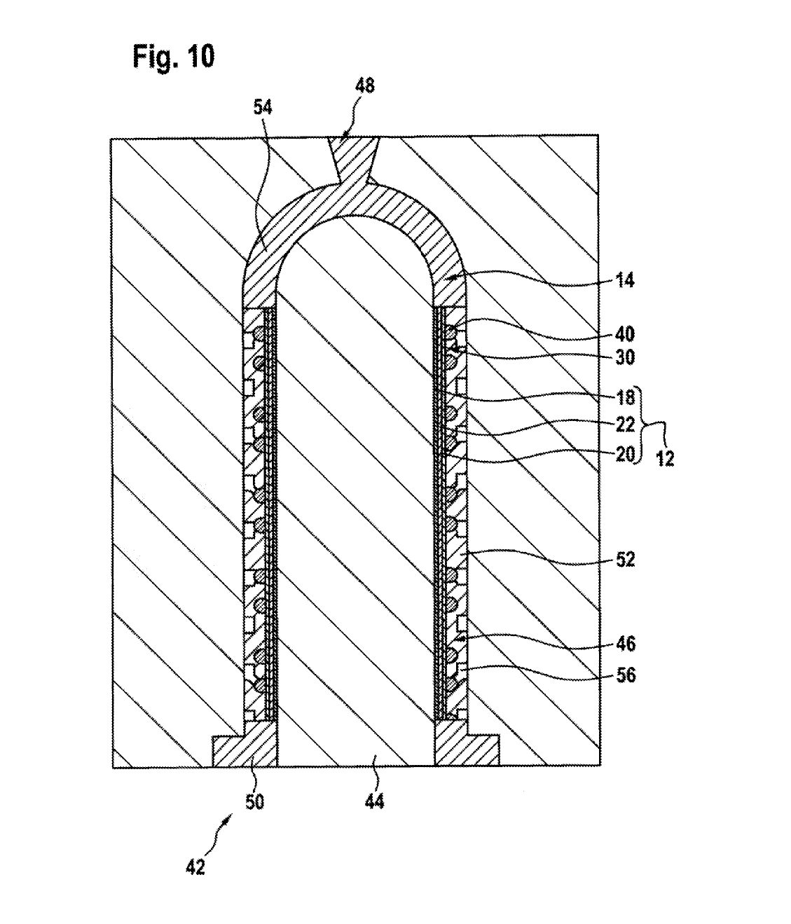

FIG. 10 shows a schematic cross section through an injection mold unit 42 that can be used in the further embodiment of the method according to the invention, said unit having injected injection molded components 50, 52, 54. The bosses 56 are designed in such a way that they do not come into contact with the structural material 40 during the introduction of the injection molding core 44 with the functional layer system 12 and the structural material 40 into the injection molding cavity 46. Accordingly, the bosses 56 are designed in such a way that they have a spacing of 30 μm to 150 μm, in the embodiment shown of 70 μm, with respect to the structural material 40 after the introduction of the functional layer system 12 and the structural material 40. This ensures that the structural material 40 is not damaged during the introduction of the injection molding core 44, wherein the desired openings 32 are formed by virtue of adhesion effects during the injection of the injection molded components 50, 52, 54, despite the spacing of the bosses 56 with respect to the structural material 40. If the clearance between the bosses 56 and the structural material 40 is nonetheless filled owing to a fault in production, a through flow of oxygen is nevertheless ultimately possible by virtue of the porosity of the central section.

As an alternative, however, it is also conceivable for the bosses 56 to be designed in such a way that they come into contact with the structural material 40 as the injection molding core 44 is introduced into the injection molding cavity 46 with the functional layer system 12 and the structural material 40.

After the setting of the injection molded components 50, 52, 54, mold parting is then carried out. That is to say that the injection molding cavity 46 is divided into two halves and the injection molding core 44 is pulled out, with the injected tubular support body 14 with the transfer material 41, the functional layer system 12 and the structural material 40 remaining thereon. The formation of the bosses 56 in parallel and opposite one another on the inner side of the injection molding cavity 46 ensures that damage to the injected tubular support body 14 during mold parting or during the division of the injection molding cavity 46 into two halves is avoided.

The remaining product is pulled or pushed off the injection molding core 44 and placed in a water bath, wherein the sugar coating of the transfer material 41 is dissolved by the water and the transfer material 41 is thus separated from the functional layer system 12.

The tubular support body 14 with the functional layer system 12 and the structural material 40 is furthermore at least partially freed from binder in the water bath. That is to say that the tubular support body 14 remains with the functional layer system 12 and the structural material 40 for 1 to 5 days in the water bath, while the water-soluble binder components contained dissolve. During this process, the binder system loses thermoplastic components (plasticizers), thus ensuring dimensional stability during the rest of the process.

The tubular support body 14 with the functional layer system 12 and the structural material 40 is then freed from binder thermally, in the embodiment shown by heating. During this process, the structural material 40 is at least partially removed, while the tunnel-like structure 16 in the tubular support body 14 substantially remains. In this method step, a pore former contained in the second injection molded component 52 is furthermore at least partially removed, likewise by heating, giving the central section 28 of the electrochemical cell 10 to be produced its porosity.

Finally, the tubular support body 14 with the functional layer system 12 is sintered in a sintering process, thereby, inter alia, making the foot section 26 and the cap section 24 gastight. In addition, residual binder is removed in the sintering process, while remaining structural material 40 and/or remaining pore former is completely removed.

Thus, method step d) in the embodiment shown is accomplished both by thermal binder removal and by a sintering process. As an alternative, however, it is also conceivable for method step d) to be accomplished only by thermal binder removal or by a sintering process.

What is claimed is:

1. An electrochemical cell (10), having at least one functional layer system (12), characterized in that at least one tubular support body (14) is formed, in which at least one tunnel-like structure (16) is formed, which adjoins the at least one functional layer system (12).

2. The electrochemical cell (10) according to claim 1, characterized in that the at least one tunnel-like structure (16) forms a channel structure.

3. The electrochemical cell (10) according to claim 1, characterized in that the at least one tunnel-like structure (16) is formed in the manner of a network.

4. The electrochemical cell (10) according to claim 1, characterized in that the at least one tunnel-like structure is of a honeycomb-like and/or ladder-like design.

5. The electrochemical cell (10) according to claim 1, characterized in that at least one opening (32) is formed in the at least one tubular support body (14).

6. The electrochemical cell (10) according to claim 1, characterized in that at least one opening (32) is connected at least substantially to the at least one tunnel-like structure (16) in terms of flow.

7. ctrochemical cell (10) according to claim 1, characterized in that a multiplicity of openings (32) is formed in the at least one tubular support body (14).

8. A method for producing an electrochemical cell (10), having at least one functional layer system (12), the method comprising the following method steps:
a) applying at least one structural material (40) to the at least one functional layer system (12), wherein the at least one structural material (40) is provided to form at least one tunnel-like structure (16) in at least one tubular support body (14), which adjoins the at least one functional layer system (12);
b) introducing the at least one functional layer system (12) into at least one injection mold unit (42);
c) injecting at least one injection molded component (50, 52, 54) into at least one injection mold unit (42); and
d) removing the structural material (40).

9. The method for producing an electrochemical cell (10) according to claim 8, characterized in that method step a) is carried out by a screen printing method and/or tampon printing method.

10. The method for producing an electrochemical cell (10) according to claim 8, characterized in that method step a) is carried out in such a way that at least one structural material (40) is formed on the at least one functional layer system (12) in an at least substantially interconnected manner.

11. The electrochemical cell (10) according to claim 1, characterized in that the at least one tunnel-like structure (16) forms a channel structure which is at least substantially interconnected in terms of flow.

12. The electrochemical cell (10) according to claim 1, characterized in that the at least one tunnel-like structure (16) is formed as at least one diffusion network and/or discharge network, through which at least one oxygen-containing and/or nitrogen-containing fluid flows.

13. The electrochemical cell (10) according to claim 1, characterized in that at least one gas access opening is formed in the at least one tubular support body (14).

14. The electrochemical cell (10) according to claim 1, characterized in that a multiplicity of openings (32) is formed in the at least one tubular support body (14), parallel to one another and/or opposite one another.

15. A method for producing an electrochemical cell (10) according to claim 1, having at least one functional layer system (12), the method comprising the following method steps:
a) applying at least one structural material (40) to the at least one functional layer system (12), wherein the at least one structural material (40) is provided to form at least one tunnel-like structure (16) in at least one tubular support body (14), which adjoins the at least one functional layer system (12);
b) introducing the at least one functional layer system (12), with the at least one structural material (40), into at least one injection mold unit (42);
c) injecting at least one injection molded component (50, 52, 54) into at least one injection mold unit (42); and
d) removing the structural material (40) by heating.

16. The method for producing an electrochemical cell (10) according to claim 15, characterized in that method step a) is carried out by means of a screen printing method and/or tampon printing method.

17. The method for producing an electrochemical cell (10) according to claim 15, characterized in that method step a) is carried out in such a way that at least one structural material (40) is formed on the at least one functional layer system (12) in an at least substantially interconnected manner, in the manner of a honeycomb and/or ladder.
